(19) United States
(12) Patent Application Publication
(10) Pub. No.: US 2023/0370869 A1
(43) Pub. Date: Nov. 16, 2023

(54) METHODS AND APPARATUSES FOR MOBILE COMMUNICATION SYSTEMS

(71) Applicant: Telefonaktiebolaget LM Ericsson (publ), Stockholm (SE)

(72) Inventors: Paola IOVANNA, Pisa (IT); Fabio CAVALIERE, Pisa (IT); Paolo DEBENEDETTI, Genova (IT); Tomas THYNI, Järfälla (SE)

(21) Appl. No.: 18/247,154

(22) PCT Filed: Oct. 2, 2020
(86) PCT No.: PCT/EP2020/077740

§ 371 Date: Mar. 29, 2023

(51) Int. Cl. H04W 24/02; H04W 24/08

(52) U.S. Cl. CPC H04W 24/02; H04W 24/08

(57) ABSTRACT

Methods and apparatuses for mobile communication systems are disclosed. According to an embodiment, there is provided a method in a mobile communication system having a radio access network, RAN, the radio access network having a first RAN node and a second RAN node connected by a transport network, the transport network having a first transport node and a second transport node, wherein the first RAN node is connected to the first transport node and the second RAN node is connected to the second transport node. The method includes, by the first transport node: determining the status of a transport network connection between the first transport node and the second transport node, generating a message indicating the status of the transport network connection, and initiating transmission of the message to the first RAN node.

### TECHNICAL FIELD

Embodiments of the disclosure generally relate to methods in mobile communication systems, and, more particularly, to methods and apparatuses for mobile communication systems comprising radio access networks (RAN) and transport networks.

### BACKGROUND

This section introduces aspects that may facilitate better understanding of the present disclosure. Accordingly, the statements of this section are to be read in this light and are not to be understood as admissions about what is in the prior art or what is not in the prior art.

A mobile network divides a region into cells with each cell covered by a radio base station (which may be 4th Generation, 4G, Evolved Node Bs, eNB, or 5th Generation, 5G, next Generation Node Bs, gNBs, for example). Mobile devices within each cell communicate with the nearest base stations via radio, where the signal is then transmitted to the core network via cables or high-frequency radio links to a terminal connected to the core network. A radio base station can be functionally separated into a base band unit (BBU) which generates and processes a baseband RF signal and a remote radio head (RRH) or remote radio unit (RRU), which creates transmit RF signals from the baseband signal.

With the advent of 5G, there is a requirement for an increase in the number of base stations. A solution to the requirement for an increase in number of base stations is C-RAN (cloud RAN or centralized RAN) architecture, which deconstructs base stations to lower costs and improves performance and scalability by moving the baseband processing to a centralized location.

The deconstruction of base stations to separate RRU and BBU creates the need for a fronthaul transport network able to carry the antenna signals using CPRI (common public radio interface) or OBSAI (open base station architecture initiative protocols). The term “fronthaul” may be used to describe the transport network in C-RAN architecture that carries signals from RRUs to BBUs. The fronthaul portion of a RAN (such as C-RAN) architecture comprises the intermediate links between the BBUs and the radio heads (or masts, radio units) at the “edge” of a cellular network. In particular, the fronthaul portion of the RAN comprises dedicated fibers carrying data in the CPRI (common public radio interface) or OBSAI (Open Base Station Architecture Initiative) format. Most of the current fronthaul links are peer-to-peer (P2P) connections between a BBU and an RRU and are based on CPRI. A CPRI line rate negotiation process typically starts when the link is up and running. The transport network may implement architecture such as a packet interface, passive optical network (PON), Wavelength Division Multiplexing-Passive Optical Network (WDM-PON), etc. Such configurations have several advantages, such as processing resources pooling, bandwidth allocation flexibility and enhanced resiliency.

In the configuration of RAN with a transport network, an automatic configuration of the transport network is preferable to simplify the operations and cut down configuration time and cost. Such automated mechanisms, for example for the configuration of a transmitter, have a setup time, during which the connection cannot be used to exchange data. A default situation for radio equipment is to restart or trigger Operation and Maintenance (O&M) recovery procedures when the radio equipment is not aware of whether a link connecting the BBU and the RRU is available.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for preventing unnecessary restarting or recovery procedures of the radio equipment.

According to an aspect of the disclosure, there is provided a method in a mobile communication system comprising a radio access network, RAN, the radio access network comprising a first RAN node and a second RAN node connected by a transport network, the transport network comprising a first transport node and a second transport node, wherein the first RAN node is connected to the first transport node and the second RAN node is connected to the second transport node, the method comprising, by the first transport node: determining the status of a transport network connection between the first transport node and the second transport node; generating a message indicating the status of the transport network connection; and initiating transmission of the message to the first RAN node.

By generating a message indicating the status of the transport network connection and initiating transmission of the message to the first RAN node, the status of the transport network connection may become known to the RAN node. Thus, the RAN may be able to detect the status of a connected transport network. This prevents undesirable actions of the RAN (e.g. restarting when it is unnecessary to restart) and enables the RAN to run automated configuration mechanisms at an appropriate time.

The message may indicate at least one of: the transport network connection is active; a transport network connection failure; a fault in the transport network connection; a temporary state in the transport network connection; a change in state of the transport network connection; the status of a transport link in the transport network; waiting for a transport connection.

The method may further comprising repeating the steps of determining, generating and initiating. The steps may be repeated when the message indicates a transport network failure or fault, and/or when the message indicates that the transport network failure or fault has been resolved.

The first radio node may comprise a remote RAN node or a central RAN node, and the second radio node may comprise the other of the remote RAN node or the central RAN node. The remote RAN node may be a remote radio unit, RRU, and the central unit may be a baseband unit, BBU. The central unit may comprise a distributed unit, DU.

The method may further comprise, by the first RAN node: receiving the message indicating the status of the transport network connection; and performing an operation based on the message.

The first RAN node may operate by at least one of: changing state to waiting for transport; changing state to transport network connection active; changing state to transport status known; using the transport network connection; changing state to transport network connection failure; maintaining a current state.

The method may further comprise the first transport node initiating a transport network connection configuration operation to configure the transport network connection between the first transport node and the second transport node.

The transport network connection configuration operation may comprise the first transport node sending a preliminary message indicating the start of the configuration operation to the first RAN node and establishing a transport network connection between the first transport node and the second transport node.

The first transport node may perform a procedure to determine a communication protocol on which the message is to be based. The procedure may comprise sending at least one message based on at least one communication protocol to the first RAN node. The message may be based on Common Public Radio Interface, CPRI, enhanced CPRI, eCPRI, Ethernet Link Fault Management, Ethernet LFM, Internet Protocol, or Operations Administration and Maintenance protocol. The message may be encapsulated within a frame of a fronthaul interface. The message may be encapsulated within the RAN node protocol. The RAN node protocol may be one of: CPRI, eCPRI, O-RAN interface.

The method may further comprise: by the second transport node: determining the status of the transport network connection; generating a second message indicating the status of the transport network connection; and initiating transmission of the second message to the second RAN node.

Hardwired connections may be used between at least one pair of: the first RAN node and the first transport node; and the second RAN node and the second transport node. The hardwired connections may comprise at least one of: fiber optic connections, microwave radio links or copper-based links.

According to an aspect of the disclosure, there is provided a first transport node of a transport network, wherein the first transport node is comprised in a mobile communication system also comprising a radio access network, RAN, the radio access network comprising a first RAN node and a second RAN node connected by a transport network, the transport network comprising the first transport node and a second transport node, wherein the first RAN node is connected to the first transport node and the second RAN node is connected to the second transport node, wherein the first transport node comprises processing circuitry and a memory containing instructions executable by the processing circuitry, whereby the first transport node is operable to: determine the status of a transport network connection between the first transport node and the second transport node; generate a message indicating the status of the transport network connection; and initiate transmission of the message to the first RAN node.

According to an aspect of the disclosure there is provided a first radio access network, RAN, node of a radio access network, RAN, the RAN comprising the first RAN node and a second RAN node connected by a transport network, the transport network comprising a first transport node and a second transport node, wherein the first RAN node is connected to the first transport node and the second RAN node is connected to the second transport node, wherein the first radio node comprises processing circuitry and a memory containing instructions executable by the processing circuitry, whereby the first RAN node is operable to: receive a message indicating the status of the transport network connection; and perform an operation based on the message.

According to an aspect of the disclosure there is provided a mobile communication system comprising a radio access network, RAN, and a transport network, the radio access network comprising the first RAN node a second RAN node connected by the transport network, the transport network comprising the first transport node and a second transport node, wherein the first RAN node is connected to the first transport node and the second RAN node is connected to the second transport node.

The mobile communication system may be configured to perform any of the methods described herein.

According to an aspect of the disclosure there is provided a computer program comprising instructions which, when the program is executed by a computer, cause the computer to carry out any of the methods described herein.

According to an aspect of the disclosure there is provided a computer-readable medium comprising instructions which, when executed on a computer, cause the computer to carry out any of the methods described herein.

An advantage of the methods disclosed herein is that the RAN is able to automatically detect the status of a connected transport network. This prevents undesirable actions of the RAN (e.g. restarting when it is unnecessary to restart) and enables the RAN to run automated configuration mechanisms at an appropriate time.

The methods are general and may apply both in case the transport domain is not controlled by an IP based protocol stack, and in the case that IP based protocols are used to configure the nodes.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a mobile communication system comprising a RAN according to an embodiment;

FIG. 2a is a flow chart illustrating a method in a communication system according to an embodiment;

FIG. 2b is a flow chart illustrating a method in a communication system according to an embodiment;

FIG. 3 is a diagram illustrating a process of messaging between components of the mobile communication system according to an embodiment in which a transport link between a first transport node and a second transport node is initially not operational;

FIG. 4 is a diagram illustrating a process of messaging between components of the mobile communication system according to an embodiment in which a fault or failure occurs in a transport link between a first transport node and a second transport node;

FIG. 5a is a block diagram illustrating a transport node according to an embodiment;

FIG. 5b is a block diagram illustrating a RAN node according to an embodiment;

FIG. 6a is a block diagram illustrating a transport node according to an embodiment; and

FIG. 6b is a block diagram illustrating a RAN node according to an embodiment.

### DETAILED DESCRIPTION

For the purpose of explanation, details are set forth in the following description in order to provide a thorough understanding of the embodiments disclosed. It will be apparent to those skilled in the art that the embodiments may be implemented without these specific details or with an equivalent arrangement.

An issue that currently exists in a mobile communication system (for example, a 3^{rd} Generation Partnership Project (3GPP), mobile communication system) comprising a radio access network (RAN) and a transport network is that, if the radio equipment (RAN equipment) such as a base station (which may be 4th Generation, 4G, Evolved Node Bs, eNB, or 5th Generation, 5G, next Generation Node Bs, gNBs, for example) connected to the transport network is not aware of the status of a transport link of the transport network between the radio equipment, the radio equipment may unnecessarily restart or trigger O&M recovery procedures rather than waiting for the transport link to become operational.

Some methods to prevent an unnecessary radio equipment restart which are currently used in RANs include a radio equipment waiting for a period of time, e.g. a hold-off time, when no transport link is detected before restarting to give the transport link an opportunity to begin running. However, this method may delay the detection of actual failures in the RAN or the transport network. If the transport link is not operational after the hold-off time the radio equipment usually restarts to try to recover from the supposed failure and this can lead to a restart of the automatic configuration (line-up) of the transport network as well. Additionally, it is not possible to determine the cause of the failure if no transport link is detected after the expiration of the hold-off time. It is also common for radio equipment to revert back to basic boot software (SW) and try to download a fresh SW image in case a failure persists over longer time.

Furthermore, when the interface between the radio equipment involves using a packet interface such as eCPRI (enhanced common public radio interface) connected to packet switched network, the time provisioned for connections in the transport network is variable and depends on the current transport network status. Therefore, the radio equipment may be attempting to connect with the transport network in a time interval where there is no provision for a transport link of the transport network to connect radio equipment.

Currently, radio access networks (RAN) and transport networks do not have in-band mechanisms to exchange information about their respective operational status. Consequently, in situations where the transport network requires time to configure (line-up), for example due to automatic transceiver settings, the radio network is not able to detect a temporary situation, such as a temporary break in the transport link, and therefore may implemented a radio equipment restart in response.

In general, the methods described herein may involve sending (in band) messages as part of a fronthaul interface between RAN equipment (RAN nodes or radio nodes), where the messages are generated by transport equipment (transport nodes) and forwarded to RAN equipment as indicators of the status of a transport link between the transport nodes. By notifying the radio equipment of the status of the transport network, unnecessary restart or triggering of recovery procedures of the radio equipment may be avoided, and the radio equipment can instead act on the basis of the status of the transport link. In some aspects of the embodiments, the mobile communication system may form part of a wireless communication network such as a 3rd Generation Partnership Project (3GPP) 4th Generation (4G) or 5th Generation (5G) network.

The methods described herein are independent of the architecture and technology of the transport network and may apply to various network topologies implemented in the transport network such as mesh, ring, or tree topologies in addition to topologies such as P2P. Thus, the transport network may implement any such architecture and/or network topologies.

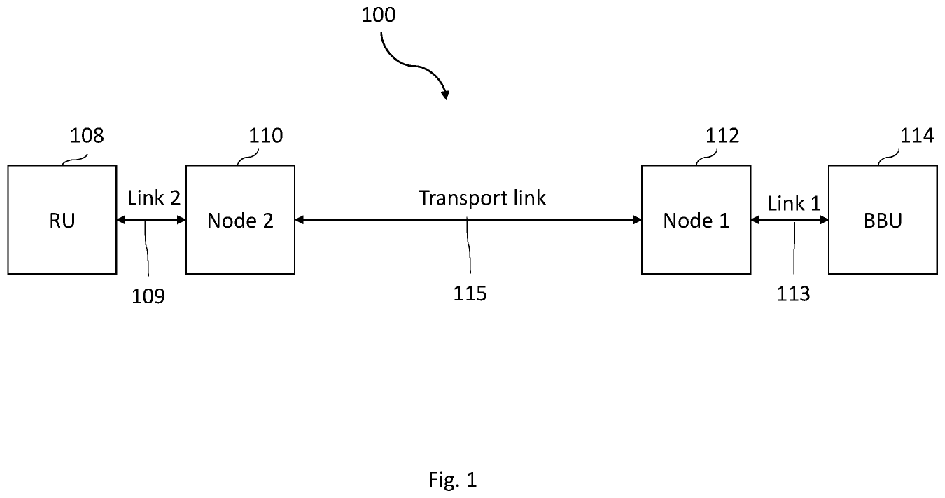

An embodiment of a RAN system to which the invention may apply is illustrated in FIG. 1. In particular, FIG. 1 illustrates a RAN network 100 comprising a transport network which connects a first radio unit (first RAN node) 114 and a second radio unit (second RAN node) 108 (a BBU and an RRU respectively in this embodiment). The transport network comprises a first transport node 112 and a second transport node 110. The first transport node 112 is connected to the first radio unit 114 by a first link 113 and the second transport node 110 is connected to the second radio unit 208 by a second link 109. The first and second links may be hardwired. In particular, the first and second links may be fiber optic connections, microwave radio links or copper-based links. The first transport node and the second transport node are connected to one another by a transport link (transport network connection) 215.

The first and second transport node may be connected using multiple different network types, including fiber link connections, microwave links, and so on.

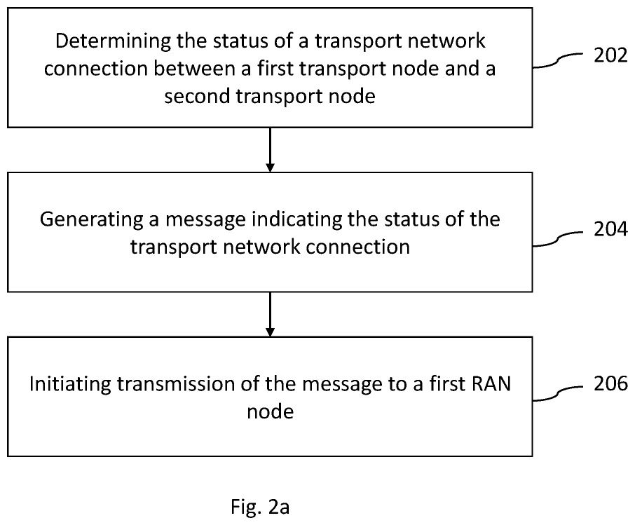

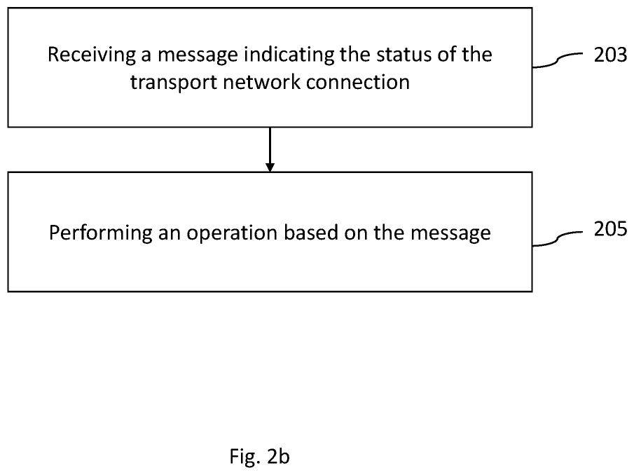

A method which may be performed by the system of FIG. 1 is outlined in FIG. 2a. FIG. 2a illustrates a method for a RAN system comprising the steps of (by a first transport node) determining the status of a transport network connection between a first transport node and a second transport node (S202), generating a message indicating the status of the transport network connection (S204), and initiating transmission of the message to a first RAN node (S206). The RAN node may operate on the basis of the message. Thus, the RAN node may operate on the basis of the status of the transport network connection. For example, the state of the RAN node may alter or remain the same on the basis of the status of the transport network connection.

In particular, the system may additionally perform the steps of the method of FIG. 2b. In particular, the method may further comprise the steps of (by a first RAN node) receiving a message indicating the status of the transport network connection (S203) and performing an operation based on the message (S205).

The first RAN node may comprise a radio unit (such as a remote radio unit, RRU), or may comprise a baseband unit (BBU) (or a distributed unit, DU). The BBU may comprise the DU. The method may also comprise the steps of (by a second transport node) determining the status of a transport network connection between the first transport node and the second transport node, generating a second message indicating the status of the transport network connection, and initiating transmission of the second message to the second RAN node. Thus, one transport node may send a message to an RRU, and one transport node may send a message to a BBU. The messages sent to the RRU and the BBU may comprise the same information. In particular, the messages may indicate the status of a transport link (transport network connection) between the two transport nodes, or between the RRU and the BBU.

The method steps may be repeated. For example, the steps of determining, generating and initiating (and the steps of receiving and performing) may be repeated. The steps may be repeated on the basis of the indication of the message. For example, these steps may be repeated when the initial message indicates a fault or failure in the transport link, and a subsequent message indicates that the link is available for transport.

The message may be an extension of the protocol used by the RAN nodes for communication with each other. In some aspects, the protocol carries radio data, e.g. on a fronthaul communication link, e.g. using CPRI or eCPRI. The message may be transmitted in-band to the RAN node. As such, the message is carried using the same protocol. e.g. CPRI or eCPRI, as the radio data. In some aspects, the message is carried in overhead of the radio data protocol. The message may indicate at least one of: the transport network connection is active; a transport network connection failure; a fault in the transport network connection; a temporary state in the transport network connection (for example, a delay in creating a link); a change in state of the transport network connection (such as a change from active to disconnected); the status of a transport link in the transport network; waiting for a transport connection. The RAN node may operate on the basis of such information. For example, the RAN node may operate by changing state to “waiting for transport” (when the message indicates a transport network connection failure or fault, or a temporary state in the transport network connection), changing state to “transport network connection active” (when the message indicates that the transport network connection is active), changing state to “transport status known” (when the message indicates the status of the transport network), changing state to “transport network connection failure” (when the message indicates a transport connection failure or fault). The RAN node may operate by using the transport network connection (e.g. communicating between the RRU and the BBU) when the message indicates that the transport network is available for use.

The method may also comprise the first transport node initiating a transport network connection configuration operation to configure the transport network connection between the first transport node and the second transport node. The transport network connection configuration operation may comprise the first transport node sending a preliminary message indicating the start of the configuration operation to the first RAN node, and establishing a transport network connection between the first transport node and the second transport node

The messages may be an additional set of CPRI or eCPRI O&M messages that are generated by an active transport node and forwarded to radio and baseband nodes to notify a temporary state or a fault in the transport network. Examples of these messages are: “Transport link up”, “Transport link failure”, “Waiting for transport”, etc. The messages may not require any modification of the RAN protocols but may be shared with the RAN nodes as “well-known” CPRI/eCPRI messages that can be interpreted by the RAN nodes. These messages may use optional fields in the CPRI/eCPRI message sets. The messages may be included in a RAN alarm detection machine state to trigger automation procedures as well as hold-off periods.

The messages may be transmitted in band (i.e. within the CPRI or eCPRI frame) by a transport node to the baseband unit or to the radio unit. They may not be a part of the RAN architecture but may be interpreted by the RAN control plane as indicators of the fronthaul link status. The method may use messages to indicate the status of a transport link. The messages may be in-band messages, i.e. carried over some available field in the frame of the fronthaul interface. The type of field may depend on the fronthaul interface, e.g. CPRI, eCPRI, F1, Ethernet LFM etc.

In any of the above embodiments, the format or way in which the messages are sent may depend on the interface between the first RAN node and the second RAN node. The message may be based on a communication protocol, such as the CPRI protocol as disclosed in “CPRI Specification V7.0”, available at http://www.cpri.info/downloads/CPRI_v_7_0_2015-10-09.pdf as of 3 Aug. 2020 or eCPRI protocol as disclosed in “eCPRI Specification V2.0”, available at https://www.gigalight.com/downloads/standards/ecpri-specification.pdf as of 3 Aug. 2020, which may be used to determine in which format messages can be sent. For example, where the first RAN node and the second RAN node are connected via a CPRI interface, the message may be sent using one of the following options:

Using bits of the word with index W=0, which are for real time vendor specific usage (according to section 7.1.4.4 of CPRI spec 7.0);

Using bits or words currently reserved for future use (section 5.1.2 of CPRI spec 7.0) (having regard for “CPRI reserved data parts shall be used only for protocol enhancements/modifications by the CPRI specification group.”);

Using some of the words dedicated to the U-plane IQ data transport, a certain number of transmitted basic frames (according to section 4.2.7.1.1 of CPRI spec 7.0).

Where the first RAN node and the second RAN node are connected via eCPRT interface, the message may be sent by using one of the following options:

Using Message Type #12-#63: Reserved (Section 3.2.4.13 of eCPRI spec 2.0). These are messages currently reserved for future eCPRI specifications;

Using Message Type #64-#255: Vendor Specific (Section 3.2.4.14 of eCPRT spec 2.0), reserved for vendor specific information;

As part of the Control and Management (C&M) Plane (Section 3.3 of eCPRI spec 2.0). Note that the C&M information will not be transmitted via the eCPRI specific protocol. The details of this information flow are out of the scope of the eCPRI specification. This information can use protocols (e.g. TCP) over the IP protocol but any other solution is not precluded. The C&M information flow will be considered as non-time-critical and utilize a small part of the total bandwidth between eCPRI entities. For example, TCP/TLS (transmission control protocol/transport layer security) may be used for this connection, but Dynamic Host Configuration Protocol version 6 (DHCPv6) may be used before the TCP/TLS connection is established and the SW is downloaded.

Where the first RAN node and the second RAN node are connected via an Ethernet LFM, 802.3ah Ethernet OAM Link Fault Management (LFM), remote fault detection may use flags and event to indicate remote loss of signal (and thus indicate a fault or failure of the transport link).

The message may be generated autonomously by the transport equipment (first transport node and second transport node) even in the absence of the transport link 115 between the first RAN node and the second RAN node. For example, this could be done using a Smart SFP where the internal FPGA can be configured to generate messages according to the most common FrontHaul protocols (CPRI, eCPRI, Ethernet LFM).

The same procedure may also apply where IP based protocols are used for the transport network. In such scenarios the messages described in procedure will be “translated” into the protocols.

The protocol on which the message is based may be determined by a transport node. For example, if the transport node is not aware what the format of the message (e.g. CPRI, eCPRI, other) to send to a RAN node should be (e.g. the format of a message appropriate for the protocol being utilized by the RAN node), the transport node may start a procedure to determine which format should be used. In particular, the transport node may send set-up messages to the RAN node, each based on an alternative protocol. In this way, the far-end protocol may be determined (the protocol on which the message should be based) by a response of the RAN node to the set-up message based on the correct protocol, or the protocol being used by the RAN node.

As an alternative to determining the protocol on which the message is based, the message format may be fixed.

The transport network may implement automated mechanisms to configure equipment such as transceivers and reconfigurable optical add-drop multiplexers. This may be required for equipment line-up or for dynamic provisioning procedures, including traffic recovery functions.

The method may apply to both the case of transport network configuration and to regular network operation, e.g. as reaction to failure.

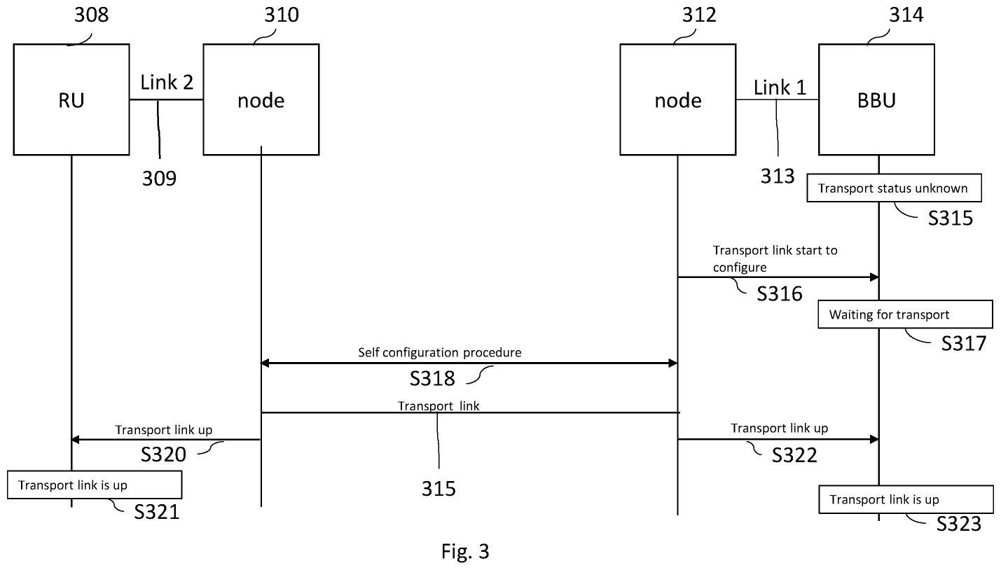

The method may be implemented as part of a configuration procedure of a transport link between first and second transport nodes. An illustration of such a procedure is shown in FIG. 3. In the embodiment of FIG. 3, the messages may be used for a configuration procedure of part of a mobile communication system.

FIG. 3 illustrates messages sent in the system depicted in FIG. 1. In particular, the system comprises a mobile communication system comprising a radio access network comprising a first RAN node 314 and a second RAN node 308. In this embodiment, the first RAN node is a BBU and the second RAN node is an RRU, however, it will be appreciated that the first RAN node may be an RRU and the second RAN node may be a BBU. The system also comprises a transport network between the first RAN node and the second RAN node comprising a first transport node 312 and a second transport node 310. In this embodiment, the first RAN node 314 is connected to the first transport node 312 via a first link 313, and the second RAN node 308 is connected to the second transport node 310 via a second link 309.

For a configuration procedure, it may be assumed that a transport link 315 between the first and second transport nodes has not been configured. It may also be assumed that the first RAN node and/or the second RAN node are not aware of the status of the transport link. The RAN nodes may therefore be in a state “Transport status unknown” S315.

The first transport node may start the transport link configuration procedure. The procedure may be started by the first transport node sending a message (for example, a preliminary message) “Transport starts to configure” to the first RAN node (BBU) over the first link 313 (S316). The BBU may then change state from “Transport status unknown” to state “Waiting for transport” S317.

The first and second node then perform a configuration procedure S318 of the transport link between the first and second transport node. The configuration procedure of the first and second transport nodes may involve each transport node comprising a tunable laser which negotiate emission wavelengths between the transport nodes. Alternatively, the configuration procedure may comprise the configuration of the inputs and outputs ports in a reconfigurable optical add drop multiplexer.

When the transport link 315 has been set up between the first and second transport node, the first transport node sends a message “Transport link up” to the first RAN node S322, and the second transport node sends a message “Transport link up” to the second RAN node S320. The state of each of the first and second RAN node changes upon receiving the message, so that the status of each of the RAN nodes is set to “Transport link is up” S323, S321. The RAN nodes may then perform their regular operations.

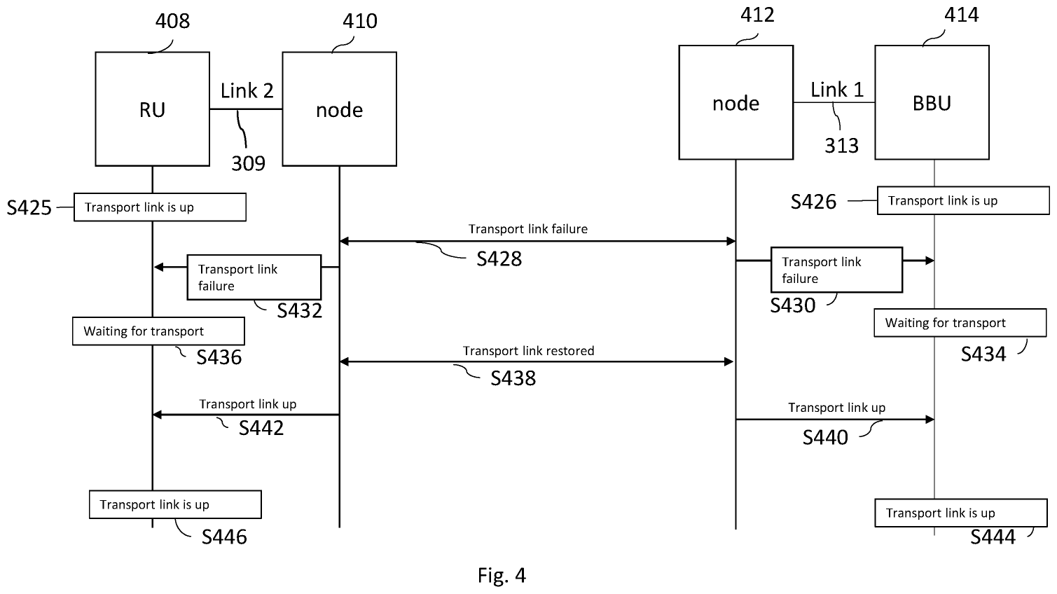

The method may be implemented as part of a regular network operation involving a transport link between first and second transport nodes. An illustration of such a procedure is shown in FIG. 4. In the embodiment of FIG. 4, the messages may be used as part of a regular network operation of a mobile communication system.

It may be assumed in this example that the transport link starts off as operational, and the first RAN node 414 and the second RAN node 408 are in the state “Transport link up” S425, S426. In this embodiment, the first RAN node is a BBU and the second RAN node is an RRU.

A fault (or failure) may occur in the transport link S428. The fault may be detected by the first transport node and the second transport node. For example, the fault may be detected by detecting a loss of signal (LoS), or due to a scheduled message not arriving. Following the fault, the first transport node may send a message to the first RAN node S430. The message may indicate a transport link failure. For example, the message may be “Transport link failure”. The second transport node may send a message to the second RAN node S432. The message may indicate a transport link failure. For example, the message may be “Transport link failure”. These messages may be sent at the same time, or one may be sent before the other.

Upon receiving the messages, the first RAN node and the second RAN node alter their status accordingly. In this instance, each RAN node alters state to “Waiting for transport” from “Transport link up” S434, 436. The BBU and RRU may also be configured to alter state to “Waiting for transport” following the detection of LoS (Loss of signal) or a similar alarm by the BBU/RRU.

The transport link may then be restored S438. The restoration of the transport link after a fault may involve a self-configuration of the transport equipment as is described in relation to FIG. 3 above. Alternatively, a different path through the network may be established.

Once the transport link is restored (for example, by the first transport node and the second transport node performing the transport link configuration as described in relation to FIG. 3), each of the first transport node and the second transport node send a message indicating that the transport link is operational, for example, a message “Transport link up”, to the first RAN node and the second RAN node respectively S440, S442. In response to receiving this message, the first RAN node and the second RAN node alter their status from “Waiting for transport” to “Transport link up” S444, S446.

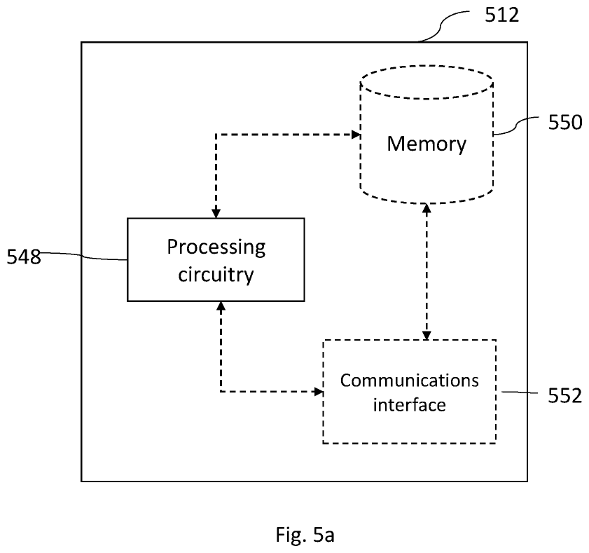

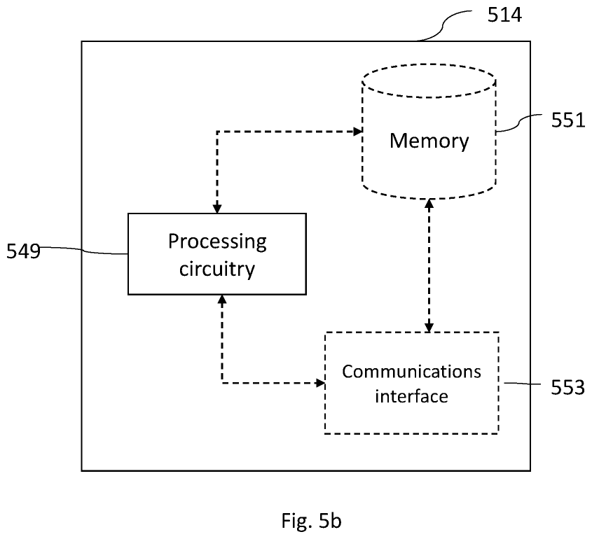

As illustrated in FIG. 5a, in aspects of embodiments the first transport node 512 comprises transport node processing circuitry (or logic) 548 (the second transport node can be configured in the same way as the first transport node). The processing circuitry 548 controls the operation of the first transport node 512 and can implement the method described herein in respect of the first transport node 512. The processing circuitry 548 can be configured or programmed to control the first transport node 512 in the manner described herein. The processing circuitry 548 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first transport node 512. In some embodiments, the processing circuitry 548 can be configured to run software to perform the method described herein in respect of the first transport node 512. The software may be containerised according to some embodiments. Thus, in some embodiments, the processing circuitry 548 may be configured to run a container to perform the method described herein in respect of the first transport node 512.

Briefly, the processing circuitry 548 of the first transport node 512 is configured to determine the status of a transport network connection between a first transport node and a second transport node. The processing circuitry 548 is further configured to generate a message indicating the status of the transport network connection and initiate transmission of the message to a first RAN node.

As illustrated in FIG. 5a, in some embodiments, the first transport node 512 may optionally comprise a transport node memory 550. The memory 550 of the first transport node 512 can comprise a volatile memory or a non-volatile memory. In some embodiments, the memory 550 of the first transport node 512 may comprise a non-transitory media. Examples of the memory 550 of the first transport node 512 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 548 of the first transport node 512 can be connected to the memory 550 of the first transport node 512. In some embodiments, the memory 550 of the first transport node 512 may be for storing program code or instructions which, when executed by the processing circuitry 548 of the first transport node 512, cause the first transport node 512 to operate in the manner described herein in respect of the first transport node 512. For example, in some embodiments, the memory 550 of the first transport node 512 may be configured to store program code or instructions that can be executed by the processing circuitry 548 of the first transport node 512 to cause the first transport node 512 to operate in accordance with the method described herein in respect of the first transport node 512. Alternatively or in addition, the memory 550 of the first transport node 512 can be configured to store any information, data, messages, requests, responses, indications, notifications, signals, or similar, that are described herein. The processing circuitry 548 of the first transport node 512 may be configured to control the memory 550 of the first transport node 512 to store information, data, messages, requests, responses, indications, notifications, signals, or similar, that are described herein.

In some embodiments, as illustrated in FIG. 5a, the first transport node 512 may optionally comprise a transport node communications interface 552. The communications interface 552 of the first transport node 512 can be connected to the processing circuitry 548 of the first transport node 512 and/or the memory 550 of first transport node 512. The communications interface 552 of the first transport node 512 may be operable to allow the processing circuitry 548 of the first transport node 512 to communicate with the memory 550 of the first transport node 512 and/or vice versa. Similarly, the communications interface 552 of the first transport node 512 may be operable to allow the processing circuitry 548 of the first transport node 512 to communicate with the RAN nodes and/or second transport nodes. The communications interface 552 of the first transport node 512 can be configured to transmit and/or receive information, data, messages, requests, responses, indications, notifications, signals, or similar, that are described herein. In some embodiments, the processing circuitry 548 of the first transport node 512 may be configured to control the communications interface 552 of the first transport node 512 to transmit and/or receive information, data, messages, requests, responses, indications, notifications, signals, or similar, that are described herein. The communications interface 552 of the first transport node may be configured to communicate with the first RAN node and/or the second transport node and/or the second RAN node.

Although the first transport node 512 is illustrated in FIG. 5a as comprising a single memory 550, it will be appreciated that the first transport node 512 may comprise at least one memory (i.e. a single memory or a plurality of memories) 34 that operate in the manner described herein. Similarly, although the first transport node 512 is illustrated in FIG. 5a as comprising a single communications interface 552, it will be appreciated that the first transport node 512 may comprise at least one communications interface (i.e. a single communications interface or a plurality of communications interface) 36 that operate in the manner described herein. It will also be appreciated that FIG. 5a only shows the components required to illustrate an embodiment of the first transport node 512 and, in practical implementations, the first transport node 512 may comprise additional or alternative components to those shown.

As illustrated in FIG. 5b, in aspects of embodiments the first RAN node 514 comprises RAN node processing circuitry (or logic) 549 (the second RAN node can be configured in the same way as the first RAN node). The processing circuitry 549 controls the operation of the first RAN node 514 and can implement the method described herein in respect of the first RAN node 514. The processing circuitry 549 can be configured or programmed to control the first RAN node 514 in the manner described herein. The processing circuitry 549 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first RAN node 514. In some embodiments, the processing circuitry 549 can be configured to run software to perform the method described herein in respect of the first RAN node 514. The software may be containerised according to some embodiments. Thus, in some embodiments, the processing circuitry 549 may be configured to run a container to perform the method described herein in respect of the first RAN node 514.

Briefly, the processing circuitry 549 of the first RAN node 514 is configured to receive a message indicating the status of the transport network connection. The processing circuitry 549 is further configured to perform an operation based on the message.

As illustrated in FIG. 5b, in some embodiments, the first RAN node 514 may optionally comprise a RAN node memory 551. The memory 551 of the first RAN node 514 can comprise a volatile memory or a non-volatile memory. In some embodiments, the memory 551 of the first RAN node 514 may comprise a non-transitory media. Examples of the memory 551 of the first RAN node 514 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 549 of the first RAN node 514 can be connected to the memory 551 of the first RAN node 514. In some embodiments, the memory 551 of the first RAN node 514 may be for storing program code or instructions which, when executed by the processing circuitry 549 of the first RAN node 514, cause the first RAN node 514 to operate in the manner described herein in respect of the first RAN node 514. For example, in some embodiments, the memory 551 of the first RAN node 514 may be configured to store program code or instructions that can be executed by the processing circuitry 549 of the first RAN node 514 to cause the first RAN node 514 to operate in accordance with the method described herein in respect of the first RAN node 514. Alternatively or in addition, the memory 551 of the first RAN node 514 can be configured to store any information, data, messages, requests, responses, indications, notifications, signals, or similar, that are described herein. The processing circuitry 549 of the first RAN node 514 may be configured to control the memory 551 of the first RAN node 514 to store information, data, messages, requests, responses, indications, notifications, signals, or similar, that are described herein.

In some embodiments, as illustrated in FIG. 5b, the first RAN node 514 may optionally comprise a RAN node communications interface 553. The communications interface 553 of the first RAN node 514 can be connected to the processing circuitry 549 of the first RAN node 514 and/or the memory 551 of first RAN node 514. The communications interface 553 of the first RAN node 514 may be operable to allow the processing circuitry 549 of the first RAN node 514 to communicate with the memory 551 of the first RAN node 514 and/or vice versa. Similarly, the communications interface 553 of the first RAN node 514 may be operable to allow the processing circuitry 549 of the first RAN node 514 to communicate with the second RAN node and/or the transport nodes. The communications interface 553 of the first RAN node 514 can be configured to transmit and/or receive information, data, messages, requests, responses, indications, notifications, signals, or similar, that are described herein. In some embodiments, the processing circuitry 549 of the first RAN node 514 may be configured to control the communications interface 553 of the first RAN node 514 to transmit and/or receive information, data, messages, requests, responses, indications, notifications, signals, or similar, that are described herein. The communications interface 553 of the first RAN node may be configured to communicate with the first transport node and/or the second transport node and/or the second RAN node.

Although the first RAN node 514 is illustrated in FIG. 5b as comprising a single memory 551, it will be appreciated that the first RAN node 514 may comprise at least one memory (i.e. a single memory or a plurality of memories) 34 that operate in the manner described herein. Similarly, although the first RAN node 514 is illustrated in FIG. 5b as comprising a single communications interface 553, it will be appreciated that the first RAN node 514 may comprise at least one communications interface (i.e. a single communications interface or a plurality of communications interface) 36 that operate in the manner described herein. It will also be appreciated that FIG. 5b only shows the components required to illustrate an embodiment of the first RAN node 514 and, in practical implementations, the first RAN node 514 may comprise additional or alternative components to those shown.

The first transport node 512 of FIG. 5a and the first RAN node 514 of FIG. 5b may be comprised in a mobile communications system.

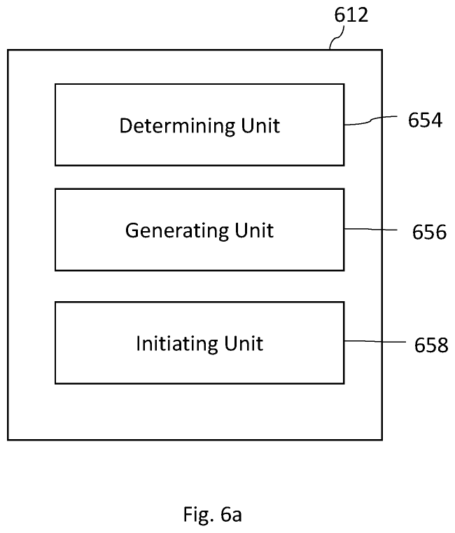

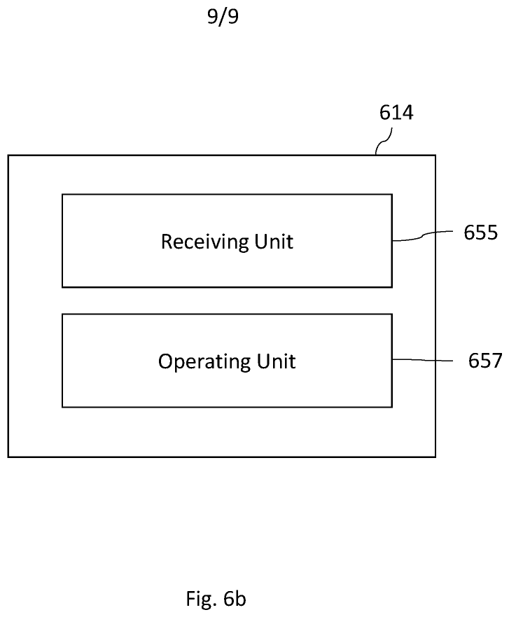

FIG. 6a illustrates a first transport node 612 according to an embodiment, the first transport node 612 comprising a determining unit 654 configured to determine the status of a transport network connection between the first transport node and the second transport node, a generating unit 656 configured to generate a message indicating the status of the transport network connection, and an initiating unit 658 configured to initiate transmission of the message to the first RAN node.

FIG. 6b illustrates a first RAN node 614 according to an embodiment, the first RAN node 612 comprising a receiving unit 655 configured to receive a message indicating the status of the transport network connection and an operating unit 657 configured to perform an operation based on the message.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method in a mobile communication system comprising a radio access network, RAN, the radio access network comprising a first RAN node and a second RAN node connected by a transport network, the transport network comprising a first transport node and a second transport node, the first RAN node being connected to the first transport node and the second RAN node being connected to the second transport node, the method comprising, by the first transport node:
determining the status of a transport network connection between the first transport node and the second transport node;
generating a message indicating the status of the transport network connection; and
initiating transmission of the message to the first RAN node.

2. The method as claimed in claim 1, wherein the message indicates at least one of: the transport network connection is active; a transport network connection failure; a fault in the transport network connection; a temporary state in the transport network connection; a change in state of the transport network connection; the status of a transport link in the transport network; waiting for a transport connection.

3. The method as claimed in claim 1, the method further comprising repeating the steps of determining, generating and initiating.

4. The method as claimed in claim 3, wherein the steps are repeated when the message indicates one of both of:
a transport network failure or fault; and that the transport network failure or fault has been resolved.

5. The method as claimed in claim 1, wherein the first RAN node comprises a remote RAN node or a central RAN node, and the second RAN node comprises the other of the remote RAN node or the central RAN node.

6. The method as claimed in claim 5, wherein the remote RAN node is a remote radio unit, RRU, and the central unit is a baseband unit, BBU.

7. (canceled)

8. The method as claimed in claim 1, wherein the method further comprises, by the first RAN node:
receiving the message indicating the status of the transport network connection; and
performing an operation based on the message.

9. The method as claimed in claim 8 wherein the first RAN node operates by at least one of: changing state to waiting for transport; changing state to transport network connection active; changing state to transport status known; using the transport network connection; changing state to transport network connection failure; maintaining a current state.

10. The method as claimed in claim 1, wherein the method further comprises the first transport node initiating a transport network connection configuration operation to configure the transport network connection between the first transport node and the second transport node.

11. The method as claimed in claim 10, wherein the transport network connection configuration operation comprises the first transport node sending a preliminary message indicating the start of the configuration operation to the first RAN node and establishing a transport network connection between the first transport node and the second transport node.

12. The method as claimed in claim 1, wherein the first transport node performs a procedure to determine a communication protocol on which the message is to be based.

13. (canceled)

14. The method as claimed in claim 1, wherein the message is based on Common Public Radio Interface, CPRI, enhanced CPRI, eCPRI, Ethernet Link Fault Management, Ethernet LFM, Internet Protocol, or Operations Administration and Maintenance protocol.

15. The method as claimed in claim 1, wherein the message is encapsulated within a frame of a fronthaul interface.

16. The method as claimed in claim 1, wherein the message is one or both encapsulated within a RAN node protocol and transmitted in-band.

17. The method as claimed in claim 16, wherein the RAN node protocol is one of: CPRI, eCPRI, O-RAN interface.

18. The method as claimed in claim 1, the method further comprising:
by the second transport node;
determining the status of the transport network connection;
generating a second message indicating the status of the transport network connection; and
initiating transmission of the second message to the second RAN node.

19. The method as claimed in claim 1, wherein hardwired connections are used between at least one pair of: the first RAN node and the first transport node; and the second RAN node and the second transport node.

20. The method as claimed in claim 19, wherein the hardwired connections comprise at least one of: fiber optic connections, microwave radio links or copper-based links.

21. A first transport node of a transport network, the first transport node being comprised in a mobile communication system also comprising a radio access network, RAN, the radio access network comprising a first RAN node and a second RAN node connected by a transport network, the transport network comprising the first transport node and a second transport node, the first RAN node being connected to the first transport node and the second RAN node being connected to the second transport node, the first transport node comprising processing circuitry and a memory containing instructions executable by the processing circuitry to configure the first transport node to:
determine the status of a transport network connection between the first transport node and the second transport node;
generate a message indicating the status of the transport network connection; and
initiate transmission of the message to the first RAN node.

22. A first radio access network, RAN, node of a radio access network, RAN, the RAN comprising the first RAN node and a second RAN node connected by a transport network, the transport network comprising a first transport node and a second transport node, the first RAN node being connected to the first transport node and the second RAN node being connected to the second transport node, the first radio node comprising processing circuitry and a memory containing instructions executable by the processing circuitry to configure the first RAN node to:
receive a message indicating the status of the transport network connection; and
perform an operation based on the message.

23.-26. (canceled)
